(19) United States
(12) Patent Application Publication
(10) Pub. No.: US 2004/0257308 A1
(43) Pub. Date: Dec. 23, 2004

(54) Single-sided driver used with a display panel and method of designing the same

(76) Inventor: Joon-hyun Yang, Suwon-si (KR)

Correspondence Address: STANZIONE & KIM, LLP, 1740 N STREET, N.W., FIRST FLOOR, WASHINGTON, DC, 20036, US

(21) Appl. No.: 10/826,278

(22) Filed: Apr. 19, 2004

(30) Foreign Application Priority Data
Jun. 20, 2003 (KR) 2003-40099

(51) Int. Cl. G09G 5/00

(52) U.S. Cl. 345/63

(57) ABSTRACT

A single-sided driver used with a display panel and a method of designing the same. The single-sided driver used with a display panel includes a single-sided driver circuit having predetermined circuit elements including energy accumulation elements and switching elements, and establishes current flow paths to generate predetermined driving voltage waveforms required for both X and Y axes electrodes, according to predetermined switching sequences to drive the display panel.

### CROSS-REFERENCE TO RELATED APPLICATIONS

This application claims the priority of Korean Patent Application No. 2003-40099, filed on Jun. 20, 2003, in the Korean Intellectual Property Office, the disclosure of which is incorporated herein in its entirety by reference.

### BACKGROUND OF THE INVENTION

1. Field of the Invention

The present invention relates to a driver used with a display panel and a method of designing the same, and more particularly, to a single-sided driver used with a display panel and a method of designing the same, in which a single-sided panel driver circuit generates driving voltages required for both X and Y axes electrodes of the display panel.

2. Description of the Related Art

A plasma display panel (PDP) is a next-generation flat panel display device that uses plasma generated by gas discharging to display text or images. In a PDP, several hundreds of thousands to several millions of pixels, depending on the size of the PDP, are arranged in the form of matrices.

FIG. 1 is a schematic diagram of a conventional alternating current (AC)-PDP sustain discharge circuit disclosed in U.S. Pat. No. 4,866,349 to Webber, et al., issued Sep. 12, 1989. In the disclosure of the AC-PDP, it is assumed that a display panel is a kind of load having a panel capacitance Cp. The basic operation of a PDP driver circuit is set forth in the above patent to Webber, et al.

Sequences for driving the PDP are divided into a reset period, an address period, and a sustain period. The reset period is for eliminating a record of a display by discharging all cells as well as eliminating wall charges. The address period is for selecting cells to be discharged, and establishing address discharging in those cells, using combinations of row/column electrodes of the panel. The sustain period is for displaying images by repeatedly sustaining discharging and recovering energy only at cells that establish wall charges by the address discharging.

In the conventional art, in order to display images on the PDP, switching operations are determined based on an address display separation (ADS) method. In the PDP of FIG. 1, switches Ys, Yg, Xs, and Xg are used as sustain switches for applying high-frequency AC pulsed-voltage to the panel during the sustain period of the PDP, and switch pairs (Ys, Xg) and (Xs, Yg) are repeatedly turned on/off in turn during the sustain period. Switches Yr, Yf, Xr, and Xf are used in an energy recovery circuit to reduce energy consumption by preventing a rapid change in panel voltage and capacitive displacement current during the sustain period. Inductors Lx and Ly are used for energy recovery. Capacitors C_Yerc and C_Xerc and diodes D_Yr, D_Xf, D_Xr, D_Yf, D_YvsC and D_YGC are passive elements, which are required for the existing energy recovery circuit proposed by Webber, et al. Typically, a circuit containing the sustain switches, the energy recovery switches, and the passive elements all together is called a sustain driver circuit. The sustain driver circuit works in the sustain period of the PDP according to the ADS method. A switch Yp is used to separate a circuit operation for the sustain discharge period from other circuit operations, e.g., circuit operations for the address period and the reset period. Switches Yrr, Yfr and Xrr are used to supply a high ramp voltage to the panel during the reset period, and work with capacitors Cset and C_Xsink to supply voltage that is greater than a source voltage, during the reset period. Switches Ysc and Ysp are used during the address period in the ADS method. In the address period, the switch Ysp is turned on and the switch Ysc is turned off, and in other periods (the reset and sustain periods) their states are reversed. For the address period, a scan driver IC 100 consisting of a shift register and voltage buffers operates to supply a horizontal synchronous signal to the PDP screen, and during other periods, the scan driver IC 100 is shorted-circuited. The specific operation of the conventional PDP driver circuit according to switching order is set forth in the U.S. Pat. No. 4,866,349.

However, the conventional PDP driver system described above with reference to FIG. 1 has to use separate panel drivers for X-axis and for Y-axis electrodes of the PDP. Accordingly, a significant number of components are required, thereby increasing the manufacturing cost and the size of the PDP driver system.

### SUMMARY OF THE INVENTION

The present invention provides a single-sided driver used with a display panel and a method of designing the same, in which the single-sided driver generates driving voltages that are required for both X and Y axes electrodes.

Additional aspects and advantages of the invention will be set forth in part in the description which follows and, in part, will be obvious from the description, or may be learned by practice of the invention.

The foregoing and/or other aspects of the present invention are achieved by providing a single-sided driver used with a display panel, the single-sided driver comprising a single-sided driver circuit having predetermined circuit elements including energy accumulation elements and switching elements, and establishing current flow paths to generate predetermined driving voltage waveforms required for both X and Y axes electrodes, according to predetermined switching sequences to drive the display panel.

In an aspect of this embodiment, the single-sided driver circuit is designed to repeatedly supply zero voltage and +/− multi-level voltages that are symmetric with respect to the zero voltage (0V), across the X and Y axes electrodes of the display panel, during a sustain discharge period.

In another aspect of this embodiment, a source voltage to be supplied to the single-sided driver circuit is set to be twice as much as a voltage that is supplied to the display panel during a gas discharge mode in the sustain discharge period.

In another aspect of this embodiment, the single-sided driver circuit comprises: an isolation and reset circuit which isolates an energy recovery path and establishes a current flow path to generate reset voltage waveforms that are supplied to both the X and Y axes electrodes, so as to eliminate wall charges in the display panel, during a reset period; a scan pulse generation circuit which establishes a current flow path to generate address discharging voltage waveforms to be supplied to the X and Y axes electrodes so as to generate wall charges in the display panel during an address period; a sustain driver circuit which establishes charging/discharging paths to charge/discharge the display panel according to the predetermined switching sequences to drive the display panel during a sustain discharge period, and establishes a current flow path to generate the reset voltage waveform and the address discharging voltage waveforms during the reset period and an address period, respectively, in combination with the isolation and reset circuit and the scan pulse generation circuit.

In yet another aspect of this embodiment, the sustain driver circuit comprises a capacitor with greater capacitance than the display panel on the charging/discharging path.

In yet another aspect of this embodiment, the capacitor is set to be charged with a voltage supplied to the display panel during a gas discharge mode in the sustain discharge period.

In yet another aspect of this embodiment, the sustain driver circuit further comprises an energy recovery circuit which recovers energy discharged from the display panel by way of an LC resonant circuit, and dispatches the recovered energy back to the display panel.

In yet another aspect of this embodiment, the sustain driver circuit is designed to have a capacitor clamp-type multi-level converting circuit structure.

In still another aspect of this embodiment, the capacitor clamp-type multi-level converting circuit structure is designed by: connecting a plurality of capacitors in series; connecting one end of the series of the capacitors to ground, and supplying a source voltage to the other end of the series of capacitors; and connecting switching elements to connection nodes of the capacitors, wherein the structure enables zero voltage and +/− multi-level voltages with respect to the zero voltage to be repeatedly supplied to the display panel during the sustain period, by changing current flow paths according to the predetermined switching sequences to drive the display panel.

In yet another aspect of this embodiment, the sustain driver circuit comprises: a block of energy accumulation elements in which first, second, third, and fourth capacitors CX1,CX2, CY1 and CY2 are connected in series, and an end of the series, i.e., a free end of the first capacitor CX1, is connected to ground, and the other end of the series, i.e., a free end of the fourth capacitor CY2, is connected to a source voltage for the sustain driver circuit; first and second inductors L1 and L2 which are used to accumulate energy discharged from the X and Y axes electrodes of the display panel, in combination with the block of energy accumulation elements; a first switching block connected between a connection node of the first and second capacitors CX1 and CX2, and the second inductor L2, which includes a plurality of switching elements Xr and Xf, and a plurality of diodes D3 and D4 and drives current to flow along an LC resonant circuit path via the second inductor L2 during the charge/discharge mode for the X-axis electrode of the display panel; a second switching block connected between a connection node of the third and fourth capacitors CY1 and CY2 and the first inductor L1, which includes a plurality of switching elements Yr and Yf, and a plurality of diodes D1 and D2, and drives current to flow along an LC resonant circuit path via the first inductor L1 during the charge/discharge mode for the Y-axis electrode of the display panel; a third switching block to establish a current flow path to separately generate predetermined voltage waveforms that are required for the X and Y axes electrodes of the display panel according to the predetermined switching sequences to drive the display panel, by connecting a first and second switching elements XL and XH, and third and fourth switching elements YL and YH in series, respectively, locating a diode DX between the second and third switching elements XH and YL, connecting a free end of the first switching element XL to ground, and connecting a free end of the fourth switching element YH to the source voltage for the sustain driver circuit, connecting a connection node of the first and second switching elements XL and XH to the second inductor L2 and the X-axis electrode of the display panel, connecting a connection node of the third and fourth switching elements YL and YH to the first inductor L1, and connecting a connection node of the second and third capacitors CX2 and CY1 to a connection node of the diode DX and the third switching element YL; and a capacitor CSTG which is located between the connection node of the third and fourth switching elements YL and YH and the isolation and reset circuit.

In yet another aspect of this embodiment, the isolation and reset circuit comprises an isolation circuit which includes a diode D_{Y} and a switching element Y_{P}, connected between the sustain driver circuit and the scan pulse generation circuit, so as to isolate the scan pulse generation circuit from the energy recovery circuit included in the sustain driver circuit during the reset period, according to a predetermined reset switching sequence; and a reset circuit which is used to separately generate reset voltage waveforms for the X and Y axes electrodes according to the predetermined switching sequences to drive the display panel by connecting a switching element Y_{fr} between a connection node of the scan pulse generation circuit and the isolation circuit, and the ground, connecting a diode D₅ and a switching element Yᵣᵣ in series between the connection node of the scan pulse generation circuit and the isolation circuit and a first reset source voltage, and connecting a switching element Xₑ between the X-axis electrode and a second reset source voltage.

The foregoing and/or other aspects of the present invention are also achieved by providing a method of designing a single-sided driver circuit to drive a display panel, the method comprising: constructing the single-sided driver circuit including predetermined circuit elements having energy accumulation elements and switching elements, wherein the circuit elements are arranged so as to establish current flow paths to generate predetermined driver voltage waveforms that are required for X and Y axes electrodes of the display panel according to predetermined switching sequences to drive the display panel.

In an aspect of this embodiment, the circuit elements are arranged so as to supply zero voltage and +/− multi-level voltages that are symmetric with respect to the zero voltage to the display panel during a sustain discharge period, in the predetermined switching sequences to drive the display panel.

In another aspect of this embodiment, a voltage to be supplied to the single-sided driver circuit is set to be twice as much as a voltage to be supplied to the display panel during a gas discharging mode in a sustain discharge period.

In yet another aspect of this embodiment, the single-sided driver circuit is designed to have a capacitor clamp-type multi-level converting circuit structure.

In yet another aspect of this embodiment, the capacitor clamp-type multi-level converting circuit structure is designed by: connecting a plurality of capacitors in series; connecting the series of the capacitors between ground and a source voltage to be supplied to a sustain driver circuit; connecting each of connection nodes of the capacitors to each of switching elements; and repeatedly supplying zero voltage, and +/− multi-level voltages that are symmetric with respect to the zero voltage, to the display panel during a sustain discharge period, by changing current flow paths according to the predetermined switching sequences to drive the display panel.

### BRIEF DESCRIPTION OF THE DRAWINGS

These and other aspects and advantages of the present invention will become apparent and more readily appreciated from the following description of the embodiments, taken in conjunction with the accompanying drawings of which:

FIG. 1 is a schematic diagram of a conventional plasma display panel driver system;

FIG. 2 is a diagram of voltage waveforms applied to an X-axis electrode, a Y-axis electrode, and an address electrode of a panel for a reset period, an address period, and a sustain period, all of which are required for a conventional plasma display panel driver system;

FIG. 3 is a schematic diagram of a single-sided driver in a display panel driver system according to an embodiment of the present invention;

FIG. 4 is a waveform diagram of major voltages/currents according to switching sequences used with a driving display panel according to FIG. 3;

FIGS. 5A through 5H show current flow paths of the single-sided driver circuit of FIG. 3, in modes 1 to 8 in a sustain discharge period according to switching sequences to drive a display panel;

FIG. 6 shows a current flow path to explain a voltage stress on a scan driver IC during a sustain discharge period according to the present invention;

FIG. 7A shows a current flow path in an X-rising reset mode;

FIG. 7B shows a current flow path in a Y-rising reset mode;

FIG. 7C shows a current flow path in an X-erase reset mode;

FIG. 7D shows a current flow path in a Y-falling reset mode; and

FIG. 8 shows a current flow path during an address discharge period.

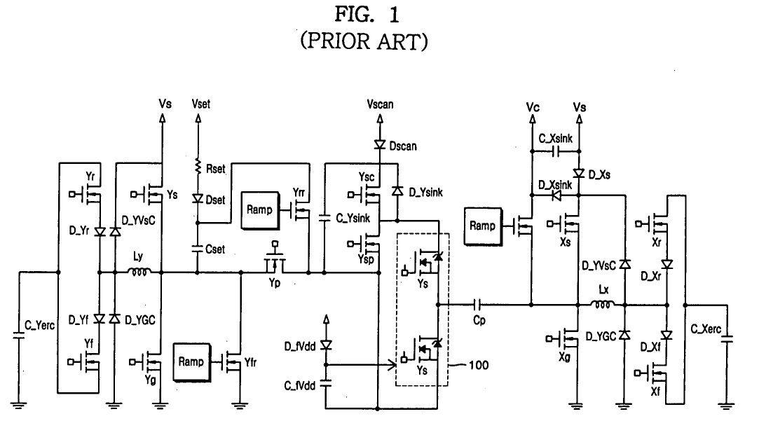

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below in order to explain the present invention by referring to the figures.

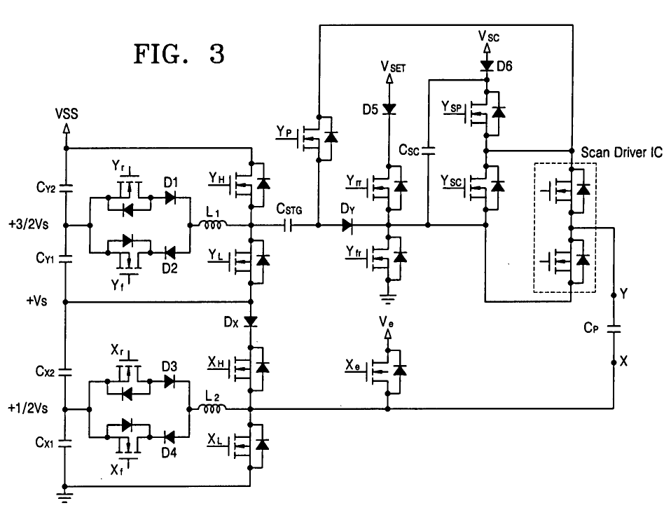

FIG. 3 is a schematic diagram of a single-sided driver in a display panel driver system according to an embodiment of the present invention.

Referring to FIG. 3, a circuit including capacitors C_{X1}, C_{X2}, C_{Y1} and C_{Y2}, MOSFET switches Xᵣ, X_{f}, Yᵣ, and Y_{f}, inductors L₁ and L₂, and diodes D₁ to D₄, is called an energy recovery circuit, in which the diodes D₁ to D₄ prevent reverse current flowing through body diodes of the MOSFET switches. The energy recovery operation is performed by series resonance of a panel capacitor Cₚ and the inductor L₁ or L₂, during a charge/discharge period of the panel.

A circuit including MOSFET switches X_{L} X_{H} Y_{L} and Y_{H} is called a sustain switching circuit.

In this embodiment of the present invention, a circuit including the energy recovery circuit, the sustain switching circuit and a capacitor C_{STG} is called a sustain driver circuit.

A MOSFET switch Yₚ and a diode D_{Y} are used to cut off a ramp voltage that is generated during a reset period from the energy recovery circuit. Accordingly, a circuit including the MOSFET switch Yₚ and the diode D_{Y} is called an isolation circuit, for convenience.

A circuit including MOSFET switches Y_{ff}, Y_{fr}, and Xₑ, and a diode D₅, is called a reset circuit.

Finally, a circuit including a scan driver IC and MOSFET switches Y_{SP} and Y_{SC} is called a scan pulse generation circuit.

Designing the circuit of FIG. 3 is characterized as follows:

1. The sustain driver circuit establishes current flow paths to repeatedly supply zero voltage (0V), and +V_{S} and −V_{S} voltages that are symmetric with respect to 0V, across X and Y axes electrodes during a sustain discharge period.

2. A source voltage to be supplied to the single-sided driver circuit according to the present invention is set to twice as much as V_{S} that is supplied to the display panel in a gas discharge mode during the sustain discharge period. That is, the source voltage is set to 2V_{S}.

3. The single-sided driver circuit according to FIG. 3 comprises an isolation and reset circuit combination that establishes a current flow path to generate reset ramp voltage waveforms for X and Y axes electrodes, so as to eliminate wall charges on the display panel while cutting off the energy recovery path during a reset period. The single-sided driver circuit also comprises a scan pulse generation circuit that establishes a current flow path to generate voltage waveforms for X and Y axes electrodes, so as to make wall charges on the display panel during an address period. The single-driver circuit also comprises a sustain driver circuit that establishes charging/discharging paths to charge/discharge the display panel according to predetermined switching sequences to drive the display panel during the sustain discharge period, and establishes predetermined current flow paths to generate a reset voltage waveform and an address discharge voltage waveform in combination with the reset circuit and the scan pulse generation circuit, respectively, during the reset period and the address period.

4. The sustain driver circuit according to FIG. 3 includes a capacitor C_{STG} that has a larger capacitance than the display panel on the charging/discharging path. The capacitor C_{STG} is designed to be charged with the voltage V_{S} that is applied to the display panel in the gas discharging mode during the sustain discharge period before a sustain discharge period.

5. The sustain driver circuit according to FIG. 3 is designed to have the structure of a capacitor clamp-type multi-level converting circuit. The structure of the capacitor clamp-type multi-level converting circuit may be efficiently realized by connecting a plurality of capacitors in series, connecting one end of the series of the capacitors to ground, and connecting the other end of the series to the source voltage to be supplied to the sustain driver circuit, connecting each of connection nodes of the capacitors to each of a plurality of switching elements, and changing the current flow paths according to a predetermined display panel switching sequence, so that 0 voltage (0V), and +/− multi level voltages that are symmetric with respect to 0V are repeatedly supplied to the display panel during the sustain discharge period.

6. The sustain driver circuit according to FIG. 3 includes a block of energy accumulation elements having first through fourth capacitors C_{X1}, C_{X2}, C_{Y1} and C_{Y2} that are connected in series, where one end of the series (one end of the first capacitor C_{X1}) is connected to ground and the other end of the series (one end of the fourth capacitor C_{Y2}) is connected to a source voltage to be supplied to the sustain driver circuit. The sustain driver circuit also includes first and second inductors L₁ and L₂ that accumulate energy discharged from the X and Y axes electrodes of the display panel in combination with the energy accumulation block, and a first switching block located between a connection node of the first and second capacitors C_{X1} and C_{X2}, and the second inductor L₂. The first switching block includes a plurality of switching elements Xᵣ and X_{f}, and a plurality of diodes D₃ and D₄, the switching elements Xᵣ and X_{f} switching a current flow to establish an L-C resonant path via the second inductor L₂ in a charge/discharge mode for the X-axis electrode of the display panel. The sustain driver circuit also includes a second switching block located between a connection node of the third and fourth capacitors C_{Y1} and C_{Y2}, and the first inductor L₁, the second switching block including a plurality of switching elements Yᵣ and Y_{f} and a plurality of diodes D₁ and D₂, the switching elements Yᵣ and Y_{f} switching a current flow to establish an L-C resonant path via the first inductor L₁ in a charge/discharge mode for the Y axis electrode of the display panel. The sustain driver circuit also includes a third switching block which establishes a current flow path to separately generate predetermined voltage waveforms that are required to drive the X and Y axes electrodes of the display panel according to predetermined switching sequences to drive the display panel. The third switching block establishes the current flow path by connecting first and second switching elements, X_{L} and X_{H}, and third and fourth switching elements Y_{L} and Y_{H}, in series, respectively, locating a diode D_{X} between the second and the third switching elements X_{H} and Y_{L}, connecting an end of the first switching element X_{L} to ground and the other end of the fourth switching element Y_{H} to the source voltage to be supplied to the sustain driver circuit, connecting a connection node of the first and second switching elements X_{L} and X_{H} to the second inductor L₂ and the X axis electrode of the display panel, connecting a connection node of the third and fourth switching elements Y_{L} and Y_{H} to the first inductor L₁, and connecting the connection node of the second and third capacitors C_{X2} and C_{Y1} to another connection node of the diode D_{X} and the third switching element Y_{L}. Finally the sustain driver circuit includes a capacitor C_{STG} that is connected between the connection node of the third and fourth switching elements Y_{L} and Y_{H}, and the isolation and reset circuit.

7. The isolation circuit according to the present invention includes a diode D_{Y} and a switching element Y_{P}, which are located between the sustain driver circuit and the scan pulse generation circuit, to cut off the scan pulse generation circuit from the energy recovery circuit that is contained in the sustain driver circuit, according to a predetermined reset switching sequence, during the reset period.

The reset circuit separately generates reset voltage waveforms for the X and Y axes electrodes according to the switching sequences to drive the display panel, by connecting a switching element Y_{fr} between a connection node of the scan pulse generation circuit and the isolation circuit, and the ground, connecting a diode D₅ and a switching element Yᵣᵣ in series between the connection node of the scan pulse generation circuit and the isolation circuit, and a first reset voltage source V_{SET}, and connecting a switching element Xₑ between the X axis electrode and a second reset voltage source Vₑ.

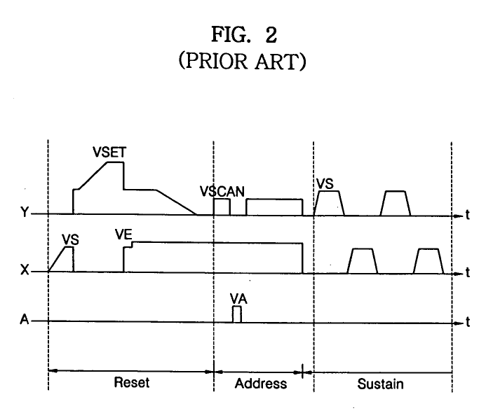

FIG. 2 shows diagrams of voltage waveforms that are required for the X and Y axes electrodes during an entire gas discharge period, according to the ADS driving method. Since voltage waveforms for the electrodes during a sustain period are continuous square voltage waveforms, an equivalent circuit without the isolation circuit, reset circuit and scan pulse generation circuit, will be used to describe operations in different modes.

The following assumptions are made in analyzing circuit operations:

1. Before the sustain discharge period, the capacitor C_{STG} has been charged with voltage +V_{S} in advance. One way of charging the capacitor C_{STG} with the voltage +V_{S} is to use a separate charging circuit (not shown). Even without the separate charging circuit, a square voltage of +2V_{S} with a 50% duty rate is supplied to the capacitor C_{STG} during the sustain period, so that the capacitor C_{STG} can naturally be charged with +V_{S} after several frames.

2. All of the energy MOSFET switches are ideal with “0” switching loss.

3. All of the capacitors C_{X1}, C_{X2}, C_{Y1} and C_{Y2} have the same capacitance.

4. The capacitance of each of the capacitors C_{X1}, C_{X2}, C_{Y1}, C_{Y2} and C_{CTG} is much greater than that of the panel capacitor C_{P}.

5. Voltages across the capacitors C_{X1}, C_{X2}, C_{Y1} and C_{Y2} are the same and equal to +V_{S}/2.

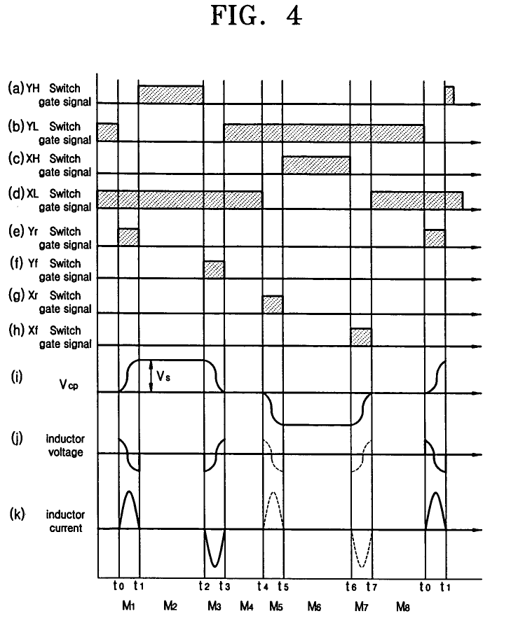

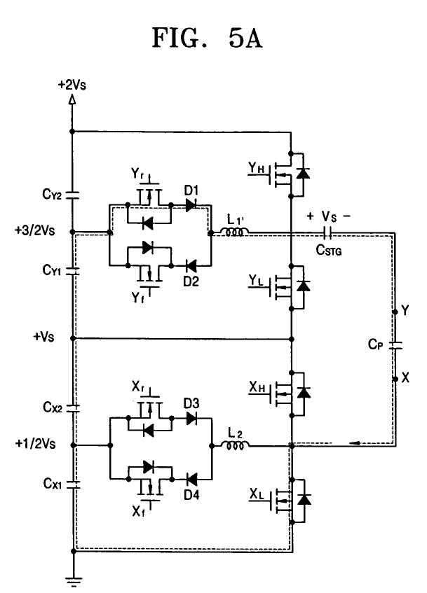

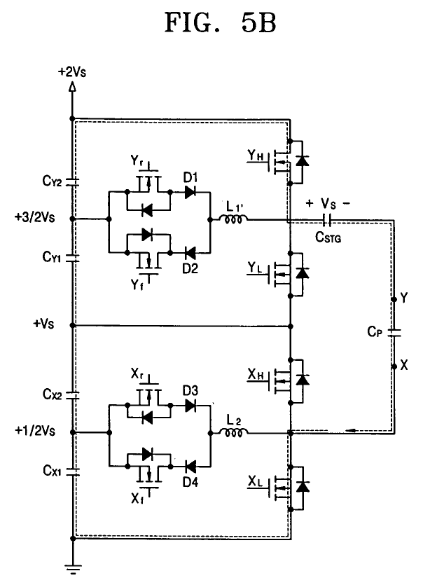

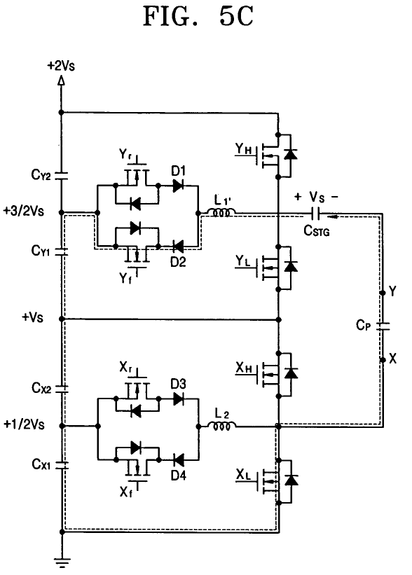

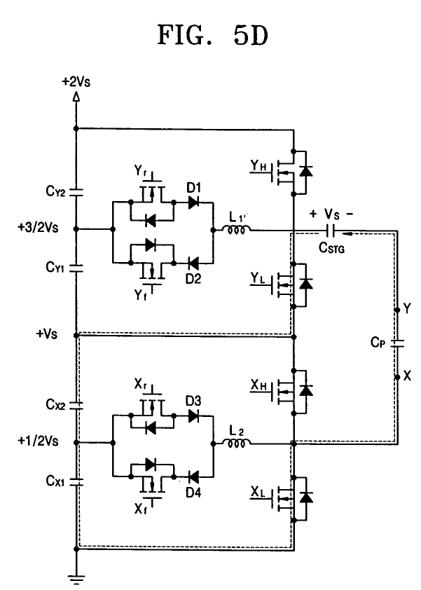

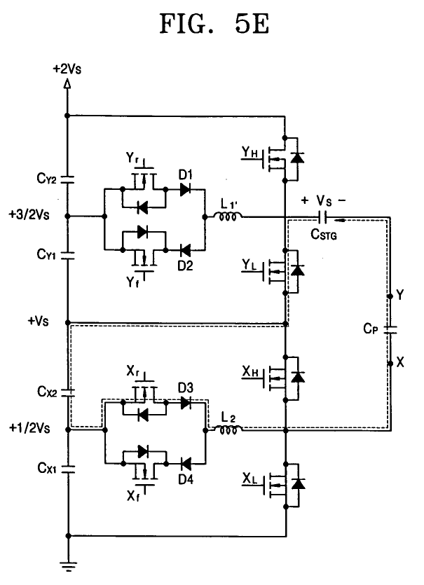

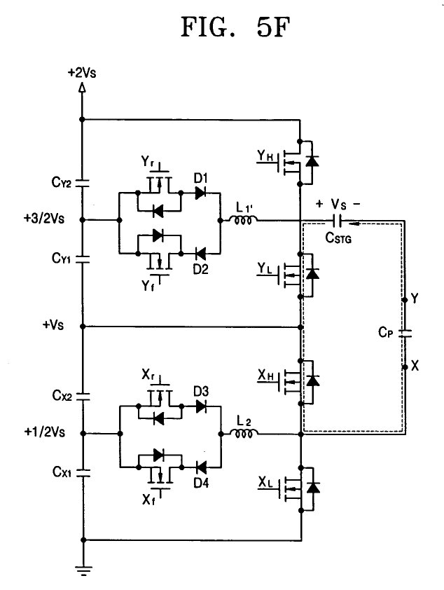

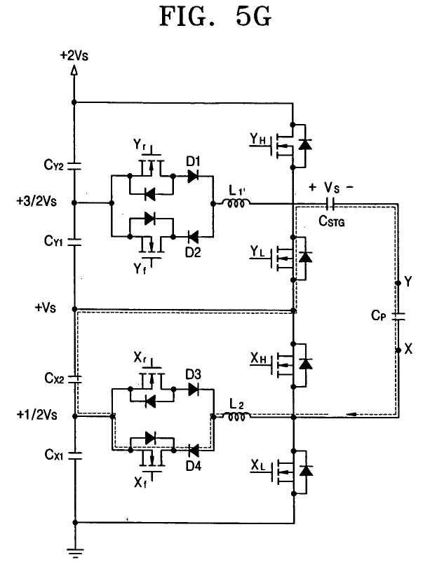

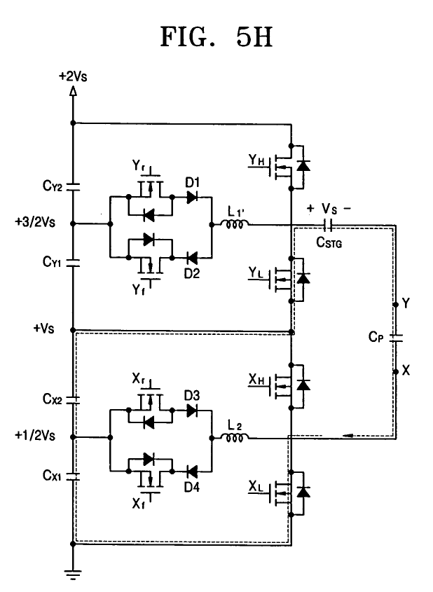

Applying the above assumptions, the AC-PDP sustain discharge period can be divided into the following 8 modes according to switching sequences during the sustain discharge period. The modes will be described with reference to FIGS. 5A through 5H showing switching sequences in the following modes 1 through 8 in accordance with FIG. 4.

(1) mode 1 (t₀≦t<t₁; pre-charge mode).

Since switching elements Y_{L} and X_{L} have been turned on before t₀, the voltage across the panel capacitor C_{P} stays at 0V. Voltages across the drain-source of the switching elements Y_{H} and X_{H} are the same, and equal to +V_{S}.

At t=t₀, the switching element Y_{L} is turned off and Yᵣ is turned on. Accordingly, energy stored in the capacitors C_{X1}, C_{X2}, and C_{Y1} moves to the capacitor C_{P} through a resonant path C_{Y1}-Yᵣ-D₁-L₁-C_{STG}-C_{P}-X_{L} as shown in FIG. 5A. Inductor current i_{L1} and the panel voltage v_{P} can be obtained in equation 1 as follows:

$$\begin{matrix}{i}_{L1} ( t ) = \frac{{V}_{S}}{2 \sqrt{{L}_{1} / {C}_{P}}} sin ω ( t - {t}_{0} ) \\ {v}_{P} ( t ) = \frac{{V}_{S}}{2} ( 1 - cos ω ( t - {t}_{0} ) ) where \\ ω = 1 / \sqrt{{L}_{1} {C}_{P}} .\end{matrix} \qquad ( 1 )$$

The panel voltage v_{P} and the voltage across the drain-source of the switching element Y_{H} increase from 0V up to +V_{S}. If Zᵣ=\sqrt{L₁/C_{P}}, the peak value of the panel current I_{P,PK} is limited to +V_{S} /(2Zᵣ).

When i_{L1}=0 at t=t₁, mode 1 is finished. A period of mode 1, T_{rY}, can be represented by the equation 2 as follows:

$${T}_{rY} = \frac{π}{ω} = π \sqrt{{L}_{1} {C}_{P}} \qquad ( 2 )$$

(2) mode 2 (t₁≦t<t₂; gas-discharge mode).

At t=t₁, switching elements Yᵣ and Y_{L} are turned off, and Y_{H} is turned on. The voltage across Y_{L} and X_{H} is limited to +V_{S}. In mode 2, as shown in FIG. 5B, the panel voltage v_{P} stays at +V_{S}, and gas discharge current flows through the panel. Though the period of mode 2 can be defined arbitrarily, it is better to set the period as short as possible because AC-PDPs need to operate at a high frequency. (3) mode 3 (t₂≦t<t₃; pre-discharge mode).

Mode 3 begins with the turning-on of switching element Y_{f} at t=t₂. As shown in FIG. 5C, energy charged in the panel capacitor C_{P} moves to the capacitors C_{Y1}, C_{X2}, and C_{X1} through an L-C resonant path X_{L}-C_{P}-C_{STG}-L₁-D₂-Y_{f}-C_{Y1}. In mode 3, the inductor current i_{L1} and the panel voltage v_{P} can be calculated by the following equations 3:

$$\begin{matrix}{i}_{L1} ( t ) = \frac{{V}_{S}}{2 \sqrt{{L}_{1} / {C}_{P}}} sin ω ( t - {t}_{2} ) \\ {v}_{P} ( t ) = \frac{{V}_{S}}{2} ( 1 - cos ω ( t - {t}_{3} ) )\end{matrix} \qquad ( 3 )$$

The panel voltage v_{P} decreases from +V_{S} to 0, and the peak current of the panel, I_{P, PK} is limited to −V_{S}/(2Zᵣ). In mode 3, a voltage across the drain-source terminals of the switch Y_{H} increases from 0 to +V_{S}. When i_{L1}=0 at t=t₃, mode 3 is finished. A period of mode 3, is equal to the period of mode 1, T_{rY}.

(4) mode 4 (t₃≦t<t₄; idle mode).

Since the switching element Y_{L} is turned on by switching with a zero-switching-voltage, no energy is dissipated by turning-on the switching elements, in theory. In mode 4, as shown in FIG. 5D, the panel voltage v_{P} stays at 0. This mode 4 is finished when the switching element X_{L} is turned off and the switching element Xᵣ is turned on at t=t₄.

(5) mode 5 (t₄≦t<t₅; pre-charge mode).

In mode 5, as shown in FIG. 5E, the energy stored in the capacitor C_{X1} moves to the panel capacitor C_{P} through a resonant path Xᵣ-D₃-L₂-C_{P}-C_{STG}-Y_{L}-C_{X2}. The inductor current i_{L2} and the panel voltage v_{P} can be obtained by the following equations 4:

$$\begin{matrix}{i}_{L2} ( t ) = \frac{{V}_{S}}{2 \sqrt{{L}_{2} / {C}_{P}}} sin ω ( t - {t}_{4} ) \\ {v}_{P} ( t ) = \frac{{V}_{S}}{2} ( 1 - cos ω ( t - {t}_{4} ) )\end{matrix} \qquad ( 4 )$$

In mode 5, the panel voltage v_{P} decreases from 0 to −VS, and the voltage across the switching element XL increases from 0 to +VS. The peak current of the panel, IP, PK is limited to VS/(2Zr). Mode 5 is finished when iL2 =0 at t=t₅. The period of mode 5, T_{rX}, can be calculated by the following equation 5:

$${T}_{rX} = {T}_{rY} = \frac{π}{ω} = π \sqrt{{L}_{1} {C}_{P}} \qquad ( 5 )$$

(6) mode 6 (t₅≦t<t₆; gas-discharge mode).

Switching elements Y_{L} and X_{H} are turned on at t=t₅. The voltage across the switching elements Y_{L} and X_{H} is limited to +V_{S}. In mode 6, as shown in FIG. 5F, the panel voltage v_{P} stays at −V_{S}.

(7) mode 7 (t₆≦t<t₇; post-discharge mode).

Mode 7 begins with the turning-on of the switching element X_{f} while the switching element Y_{L} is turned on. Energy charged in the panel capacitor C_{P} is fully recovered at the capacitor C_{X1} through a resonant path C_{X2}-Y_{L}-C_{STG}-C_{P}-L₂-D₄-X_{f}, as shown in FIG. 5G. Current iL2 and the panel voltage v_{P} can be calculated by the following equations 6:

$$\begin{matrix}{i}_{L2} ( t ) = \frac{{V}_{S}}{2 \sqrt{{L}_{2} / {C}_{P}}} sin ω ( t - {t}_{6} ) \\ {v}_{P} ( t ) = \frac{{V}_{S}}{2} ( 1 - cos ω ( t - {t}_{6} ) )\end{matrix} \qquad ( 6 )$$

The panel voltage v_{P} increases from −V_{S} to 0, and the peak current of the panel, l_{P, PK} is limited to V_{S}/(2Zᵣ). Mode 7 is finished when i_{L1}=0 at t=t₇. The period of mode 7, T_{f1}, is equal to the period of mode 5.

(8) mode 8 (t₇≦t<t₈; ground mode).

As shown in FIG. 5H, the switching element X_{L} is turned on by switching with a zero-voltage, and the panel voltage v_{P} stays at “0” during mode 8.

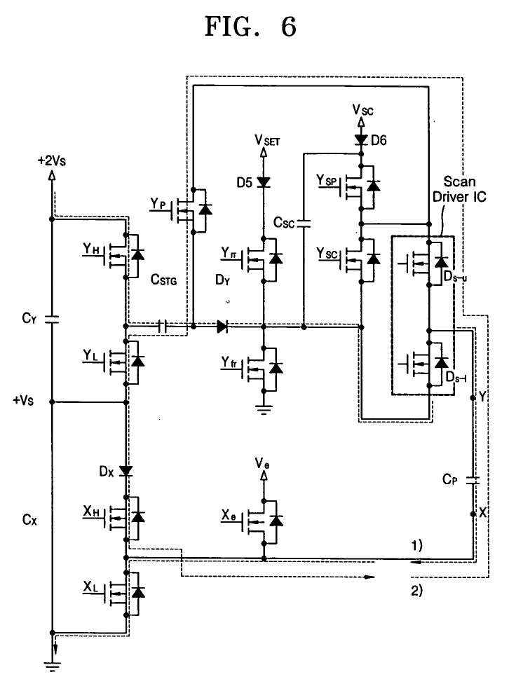

FIG. 6 is a circuit diagram of the single-sided driver of FIG. 3, where a portion involved in the energy recovery is deleted for convenience of circuit analysis during the reset period and the address period.

A path 1) shows a current flow to charge the Y-axis electrode of the panel capacitor during the sustain discharge period. Since the current flows through a body diode Dₛ₋₁ connected to a lower one of two MOSFETs of the scan driver IC, the voltage stress across the scan driver IC is identical to that of the conventional scan driver IC.

A path 2) shows a current flow to discharge the Y-axis electrode of the panel. Since the current flows through a body diode Dₛ₋ᵤ connected to an upper one of the two MOSFETs of the scan driver IC, the voltage stress across the scan driver IC is identical to that of the conventional circuit (scan driver IC).

The reset period will now be described as follows.

(1) X-rising reset mode.

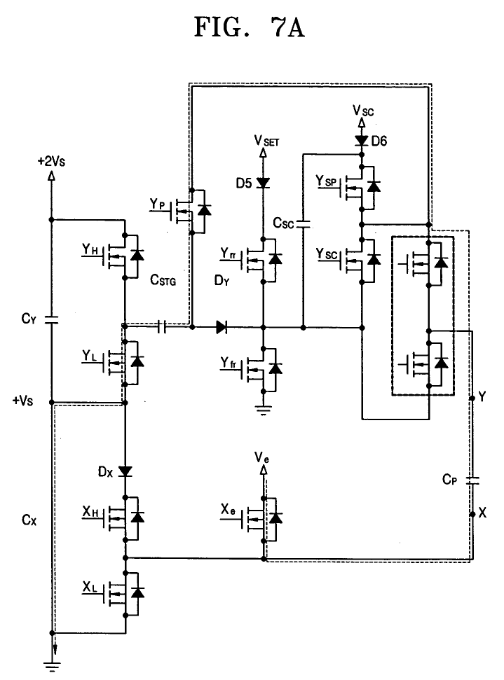

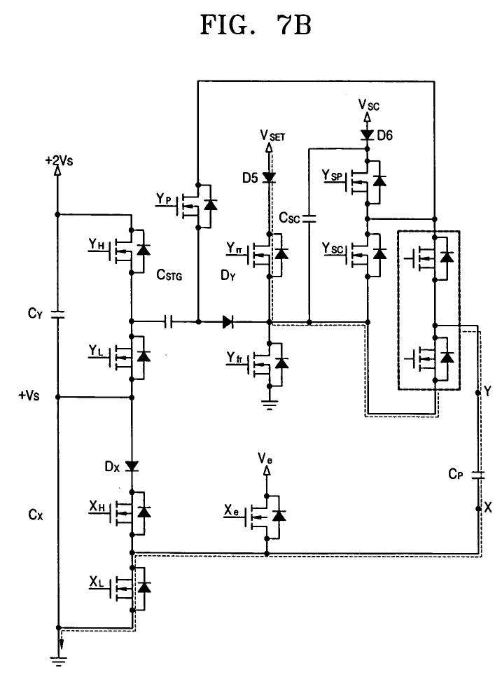

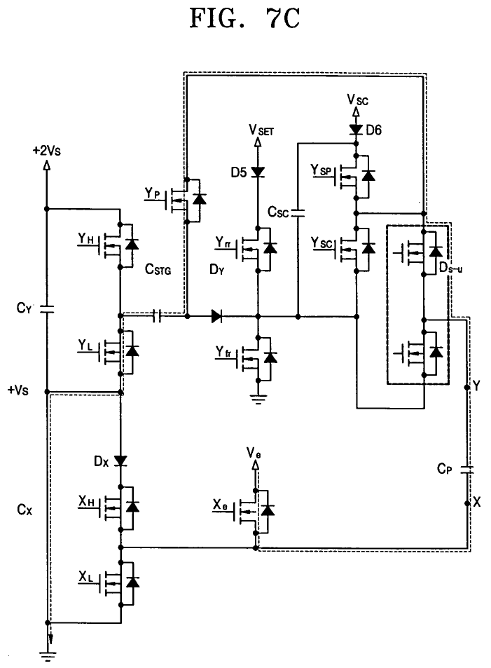

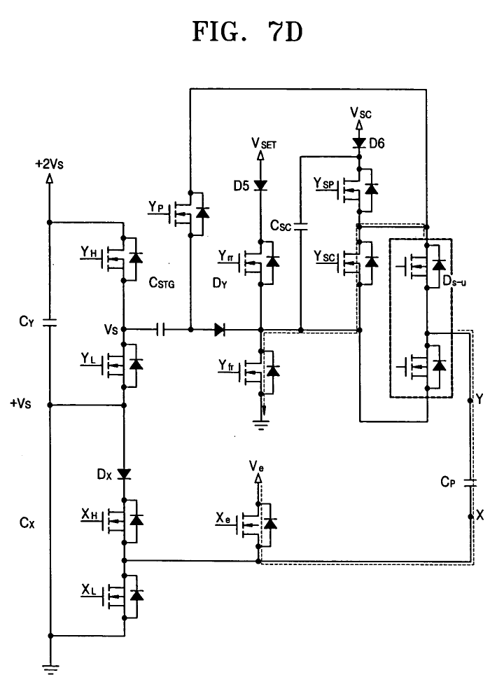

In X-rising reset mode, as shown in FIG. 7A, the Y-axis electrode is grounded by turning on the switching element Y_{L}, and then a voltage which linearly rises up to Vₑ with a simple integrator using the Miller effect is supplied to a gate of the switching element Xₑ. The voltage at the X axis electrode linearly increases, and this X-rising reset mode comes to an end when the voltage at the X axis reaches Vₑ.

(2) Y-rising reset mode.

In Y-rising reset mode, as shown in FIG. 7B, the voltage +V_{S} is supplied to the Y-axis electrode by turning on the switching elements Y_{H} and X_{L1} and then a rising ramp voltage is supplied to the Y-axis electrode by driving the switching element Yᵣᵣ. At this time, the rising ramp voltage at the Y-axis electrode rises up to +V_{SET} by supplying a linear ramp voltage using the Miller effect to the gate of the switching element Yᵣᵣ.

(3) X-erase reset mode.

In X-erase reset mode, as shown in FIG. 7C, X-erase (that is, erasing wall-charges at the X-axis electrode) is enacted by supplying Vₑ voltage to the X-axis electrode when the switching element Xₑ is turned on. At this time, however, overcurrent may flow through a body diode connected to the switching element X_{H}, and therefore a diode D_{X} is used to prevent the overcurrent.

(4) Y-falling reset mode.

In Y-falling reset mode, as shown in FIG. 7D, switching elements Y_{H} and Y_{P} are turned on. The panel voltage v_{P} is clamped into +V_{S} through a body diode Dₛ₋ᵤ via the switching element Y_{P}. Then, switching elements Y_{H} and Y_{P} are turned off and switching elements Y_{SC} and Y_{fr} are turned on. At this time, the voltage at the Y-axis electrode drops to the ground level.

Finally, the address period will now be described.

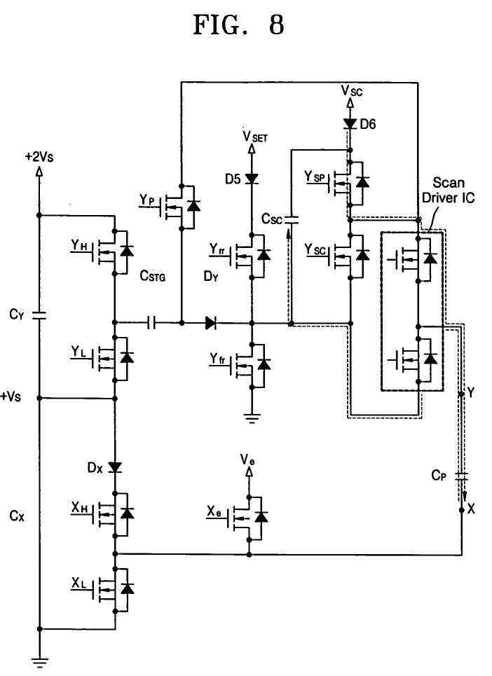

As shown in FIG. 8, when the voltage at the Y-axis electrode drops to the ground level, a capacitor C_{SC} is charged with voltage V_{SC}, by which the scan driver IC is driven. When a voltage V_{SC} is supplied to the scan driver IC by turning on the switching element Y_{SP}, the address discharging for each line occurs. At this time, the switching element Y_{L} is turned on and the voltage at the Y-axis electrode basically stays at the ground level, and the switching element Xₑ is turned on and the voltage at the X-axis electrode stays at Vₑ.

As described above, the single-sided display panel driver shown in FIG. 3 separately generates voltages that are required for the X and Y axes electrodes during the sustain discharge period, the address period and the reset period, according to switching sequences to drive the display panel. The circuit structure of the single-sided display panel driver is simpler than the conventional art, with a reduced number of parts, and has enhanced reliability and energy efficiency.

The present invention can be realized as a method, an apparatus, and a system. When the present invention is manifested in computer software, components of the present invention may be replaced with code segments that are necessary to perform the required action. Programs or code segments may be stored in media readable by a processor, and transmitted as computer data that is combined with carrier waves via a transmission media or a communication network. The media readable by a processor include anything that can store and transmit information, such as, electronic circuits, semiconductor memory devices, ROM, flash memory, EEPROM, floppy discs, optical discs, hard discs, optical fiber, radio frequency (RF) networks, etc. The computer data also includes any data that can be transmitted via an electric network channel, optical fiber, air, electromagnetic field, RF network, etc.

Although the present invention has been shown and described with reference to preferred embodiments thereof, it will be appreciated by those skilled in the art that various changes may be made to the preferred embodiments without departing from the spirit and scope of the invention as defined by the appended claims and their equivalents.

What is claimed is:

1. A single-sided driver used with a display panel, the single-sided driver comprising:
a single-sided driver circuit having predetermined circuit elements including energy accumulation elements and switching elements, and establishes current flow paths to generate predetermined driving voltage waveforms required for both X and Y axes electrodes according to predetermined switching sequences to drive the display panel.

2. The driver of claim 1, wherein the single-sided driver circuit repeatedly supplies zero voltage and +/− multi-level voltages that are symmetric with respect to the zero voltage across the X and Y axes electrodes of the display panel during a sustain discharge period.

3. The driver of claim 1, wherein a source voltage to be supplied to the single-sided driver circuit is set to be twice as much as a voltage that is supplied to the display panel during a gas discharge mode in the sustain discharge period.

4. The driver of claim 1, wherein the single-sided driver circuit comprises:
an isolation and reset circuit combination which isolates an energy recovery path and establishes a current flow path to generate reset voltage waveforms that are supplied to both the X and Y axes electrodes to eliminate wall charges in the display panel during a reset period;
a scan pulse generation circuit which establishes a current flow path to generate address discharging voltage waveforms to be supplied to the X and Y axes electrodes to generate wall charges in the display panel during an address period;
a sustain driver circuit which establishes charging/discharging paths to charge/discharge the display panel according to the predetermined switching sequences to drive the display panel during a sustain discharge period, and establishes a current flow path to generate the reset voltage waveform and the address discharging voltage waveforms during the reset period and the address period, respectively, in combination with the isolation and reset circuit and the scan pulse generation circuit.

5. The driver of claim 4, wherein the sustain driver circuit comprises a capacitor with greater capacitance than the display panel on the charging/discharging path.

6. The driver of claim 5, wherein the capacitor is set to be charged with a voltage supplied to the display panel during a gas discharge mode in the sustain discharge period.

7. The driver of claim 4, wherein the sustain driver circuit further comprises an energy recovery circuit which recovers energy discharged from the display panel by way of an LC resonant circuit and dispatches the recovered energy back to the display panel.

8. The driver of claim 4, wherein the sustain driver circuit is designed to have a capacitor clamp-type multi-level converting circuit structure.

9. The driver of claim 8, wherein the capacitor clamp-type multi-level converting circuit structure is designed by:
connecting a plurality of capacitors in series;
connecting one end of the series of the capacitors to ground and supplying a source voltage to the other end of the series of capacitors; and
connecting switching elements to connection nodes of the capacitors,
wherein the structure enables zero voltage and +/− multi-level voltages that are systematic with respect to the zero voltage to be repeatedly supplied to the display panel during the sustain discharge period by changing current flow paths according to the predetermined switching sequences to drive the display panel.

10. The driver of claim 4, wherein the sustain driver circuit comprises:
a block of energy accumulation elements in which first, second, third, and fourth capacitors are connected in series, a first end of the series is connected to a ground, and the other end of the series is connected to a source voltage of the sustain driver circuit;
first and second inductors used to accumulate energy discharged from the X and Y axes electrodes of the display panel in combination with the block of energy accumulation elements;
a first switching block connected between a connection node of the first and second capacitors and the second inductor to drive current to flow along an LC resonant circuit path via the second inductor during the charge/discharge mode for the X-axis electrode of the display panel;
a second switching block connected between a connection node of the third and fourth capacitors and the first inductor to drive current to flow along an LC resonant circuit path via the first inductor during the charge/discharge mode for the Y-axis electrode of the display panel;
a third switching block to establish a current flow path to separately generate predetermined voltage waveforms that are required for the X and Y axes electrodes of the display panel according to the predetermined switching sequences to drive the display panel by connecting a first and a second switching element and a third and a fourth switching element in series, respectively, locating a first diode between the second and third switching elements, connecting a free end of the first switching element to ground, and connecting a free end of the fourth switching element to the source voltage for the sustain driver circuit, connecting a connection node of the first and second switching elements to the second inductor and the X-axis electrode of the display panel, connecting a connection node of the third and fourth switching elements to the first inductor, and connecting a connection node of the second and third capacitors to a connection node of the diode between the second and third switching elements and the third switching element; and
a capacitor is located between the connection node of the third and fourth switching elements and the isolation and reset circuit.

11. The driver of claim 10, wherein the first switching block comprises a plurality of switching elements and a plurality of diodes.

12. The driver of claim 10, wherein the second switching bock comprises a plurality of switching elements and a plurality of diodes.

13. The driver of claim 4, wherein the isolation and reset circuit combination comprises:
an isolation circuit including a second diode and a fifth switching element connected between the sustain driver circuit and the scan pulse generation circuit, so as to isolate the scan pulse generation circuit from the energy recovery circuit included in the sustain driver circuit during the reset period, according to a predetermined reset switching sequence; and
a reset circuit used to separately generate reset voltage waveforms for the X and Y axes electrodes according to the predetermined switching sequences to drive the display panel by connecting a sixth switching element between a connection node of the scan pulse generation circuit and the isolation circuit, and the ground, connecting a third diode and a seventh switching element in series between the connection node of the scan pulse generation circuit and the isolation circuit and a first reset source voltage, and connecting an eighth switching element between the X-axis electrode and a second reset source voltage.

14. A method of designing a single-sided driver circuit to drive a display panel, the method comprising:
constructing the single-sided driver circuit including predetermined circuit elements having energy accumulation elements and switching elements,
wherein the circuit elements are arranged so as to establish current flow paths to generate predetermined driver voltage waveforms that are required for X and Y axes electrodes of the display panel according to predetermined switching sequences to drive the display panel.

15. The method of claim 14, wherein the circuit elements are arranged to supply zero voltage and +/− multi-level voltages that are symmetric with respect to the zero voltage to the display panel during a sustain discharge period, in the predetermined switching sequences to drive the display panel.

16. The method of claim 14, wherein a voltage to be supplied to the single-sided driver circuit is set to be twice as much as a voltage to be supplied to the display panel during a gas discharging mode in a sustain discharge period.

17. The method of claim 14, wherein the single-sided driver circuit is designed to have a capacitor clamp-type multi-level converting circuit structure.

18. The method of claim 17, wherein the capacitor clamp-type multi-level converting circuit structure is designed by:
connecting a plurality of capacitors in series;
connecting the series of the capacitors between ground and a source voltage to be supplied to a sustain driver circuit;
connecting each of connection nodes of the capacitors to each of switching elements; and
repeatedly supplying zero voltage, and +/− multi-level voltages that are symmetric with respect to the zero voltage, to the display panel during a sustain discharge period, by changing current flow paths according to the predetermined switching sequences to drive the display panel.

19. A single-sided driver circuit to drive X and Y electrodes of a display panel, comprising:
an isolation and reset circuit combination to establish a current flow path to generate reset ramp voltage waveforms for the X and Y axes electrodes to eliminate wall charges on the display panel while cutting off the energy recovery path during a reset period;
a scan pulse generation circuit connected with the isolation and reset circuit combination and the X and Y axes electrodes to establish a current flow path to generate voltage waveforms for the X and Y axes electrodes to make wall charges on the display panel during an address period; and
a sustain driver circuit connected with the isolation and reset circuit combination and the X and Y axes electrodes to establish charging/discharging paths to charge/discharge the display panel according to predetermined switching sequences to drive the display panel during the sustain discharge period, and to establish predetermined current flow paths to generate a reset voltage waveform and an address discharge voltage waveform in combination with the reset circuit and the scan pulse generation circuit, respectively, during the reset period and the address period.

20. The single-sided driver circuit of claim 19, wherein the sustain driver circuit comprises:
first, second, third and fourth capacitors connected in series, one end of the series being connected to a ground and another end of the series being connected to a source voltage;
first, second, third and fourth switching elements connected in series, one end of the series being connected to the ground and another end being connected to the source voltage;
a first switching block and first inductor combination being connected at one end to a node connecting the first and second capacitors and at another end to a node connecting the first and second switching elements;
a second switching block and second inductor combination being connected at one end to a node connecting the third and fourth capacitors and at another end to a node connecting the third and fourth switching elements; and
a fifth capacitor connected at one end to the node connecting the third and fourth switching elements and the isolation and reset circuit combination.

21. The single-sided driver circuit of claim 19, wherein the isolation and reset circuit combination comprises:
an isolation circuit including a diode and a fifth switching element connected between the sustain driver circuit and the scan pulse generation circuit to isolate the scan pulse generation circuit during the reset period according to a predetermined reset switching sequence; and
a reset circuit to separately generate reset voltage waveforms for the X and Y axes electrodes according to the predetermined switching sequences to drive the display panel by connecting a sixth switching element between a connection node of the scan pulse generation circuit and the isolation circuit, and the ground, connecting a third diode and a seventh switching element in series between the connection node of the scan pulse generation circuit and the isolation circuit and a first reset source voltage, and connecting an eighth switching element between the X-axis electrode and a second reset source voltage.

22. A computer readable medium including data to perform a method of to providing driving voltages required for X and Y axes electrodes of a display panel, the method comprising:
providing current flow paths to generate predetermined driving voltage waveforms required for both X and Y axes electrodes according to predetermined switching sequences to drive the display panel.

23. The computer readable medium of claim 22, further comprising data to perform the method of repeatedly supplying zero voltage and +/− multi-level voltages that are symmetric with respect to the zero voltage across the X and Y axes electrodes of the display panel during a sustain discharge period.
